(19) United States
(12) Patent Application Publication
(10) Pub. No.: US 2024/0303035 A1
(43) Pub. Date: Sep. 12, 2024

(54) SORTING CIRCUIT AND OPERATING METHOD THEREOF

(71) Applicant: SK hynix Inc., Gyeonggi-do (KR)

(72) Inventors: Joo Young KIM, Gyeonggi-do (KR); Tae Young Ahn, Gyeonggi-do (KR)

(21) Appl. No.: 18/365,218

(22) Filed: Aug. 4, 2023

(30) Foreign Application Priority Data
Mar. 7, 2023 (KR) 10-2023-0030170

(51) Int. Cl. G06F 7/24; G06F 7/02

(52) U.S. Cl. CPC G06F 7/24; G06F 7/02

(57) ABSTRACT

A sorting circuit includes an input buffer, a sorting buffer, a comparing circuit and a processing circuit. The input buffer sequentially receives values and sequentially store therein the values. The sorting buffer stores therein selected ones from among the values as each of the values is inserted thereto or discarded. The comparing circuit compares an input value currently received from among the values with each of a previous value and sorted values and output an input value comparison result. The previous value is a value that the input buffer receives immediately before receiving the input value, from among the values, and the sorted values are values stored in the sorting buffer immediately before the previous value is discarded or inserted into the sorting buffer. The processing circuit selectively inserts, based on the input value comparison result, the input value into the sorting buffer.

The present application claims priority under 35 U.S.C. § 119 (a) to Korean application number 10-2023-0030170, filed on Mar. 7, 2023, which is incorporated herein by reference in its entirety as set forth in full.

### BACKGROUND

### 1. Technical Field

Various embodiments of the present disclosure relate generally to machine learning technology and, more particularly, to a sorting circuit.

### 2. Related Art

In the field of machine learning technology, a sorting algorithm for arranging a plurality of values is developed to perform a sorting operation in a faster and more efficient way. The sorting operation may be performed through a sorting circuit, which is separate from a central processing unit (CPU), in order to reduce the overhead of the CPU.

### SUMMARY

In an embodiment of the present disclosure, a sorting circuit may include an input buffer, a sorting buffer, a comparing circuit and a processing circuit. The input buffer may sequentially receive values and sequentially store therein the values. The sorting buffer may store therein selected ones from among the values as each of the values is inserted thereto or discarded. The comparing circuit may compare an input value currently received from among the values with each of a previous value and sorted values and output an input value comparison result, wherein the previous value is a value that the input buffer receives immediately before receiving the input value, from among the values, and the sorted values are values stored in the sorting buffer immediately before the previous value is discarded or inserted into the sorting buffer. The processing circuit may selectively insert, based on the input value comparison result, the input value into the sorting buffer.

In an embodiment of the present disclosure, an operating method of a sorting circuit may include receiving, by a comparing circuit, a current input value, a previous value and sorted values to compare the current input value with each of the previous value and the sorted values; outputting, by the comparing circuit, an input value comparison result to a processing circuit; and selectively inserting, by the processing circuit, the current input value into a sorting buffer based on the input value comparison result.

In an embodiment of the present disclosure, a sorting circuit may include a sorting buffer and a processing circuit. The sorting buffer may store therein a predetermined number of values that are selected in a descending order from among sequentially received values. The processing circuit may determine to discard an input value currently received when the input value is equal to or greater than only one of sorted values and smaller than a previous value, which is received immediately before receiving the input value. The processing circuit may determine to insert the input value into the sorting buffer when the input value is equal to or greater than at least two of the sorted values. The sorted values may be values stored in the sorting buffer immediately before the previous value is discarded or inserted into the sorting buffer.

In an embodiment of the present disclosure, a method of sorting values may include sequentially receiving values; comparing a currently received input value with each of a previously received value and sorted values; and selectively inserting the currently received input value into the sorted values based on a result of the comparison. The selectively inserting the currently received input value into the sorted values may include discarding the currently received input value without inserting the currently received input value when the currently received input value is smaller than the sorted values. The selectively inserting the current input value into the sorting buffer may include inserting the currently received input value into the sorted values when the currently received input value is equal to or greater than at least one of the sorted values and equal to or greater than the previous value.

### BRIEF DESCRIPTION OF THE DRAWINGS

FIG. 1 is a block diagram illustrating a sorting circuit in accordance with an embodiment of the present disclosure.

FIG. 2 is a block diagram illustrating a comparing circuit of FIG. 1 in detail in accordance with an embodiment of the present disclosure.

FIG. 3 is a timing diagram for describing an operation of the sorting circuit of FIG. 1 in accordance with an embodiment of the present disclosure.

FIGS. 4 to 10 are diagrams for describing operations of a processing circuit of FIG. 1 for various cases in accordance with an embodiment of the present disclosure.

FIG. 11 is a flowchart for describing an operation of the sorting circuit of FIG. 1 in accordance with an embodiment of the present disclosure.

### DETAILED DESCRIPTION

Hereinafter, embodiments of the present disclosure will be described below with reference to the accompanying drawings.

In accordance with embodiments of the present disclosure, provided may be a sorting circuit capable of efficiently performing a sorting operation with minimized latency, and an operating method thereof.

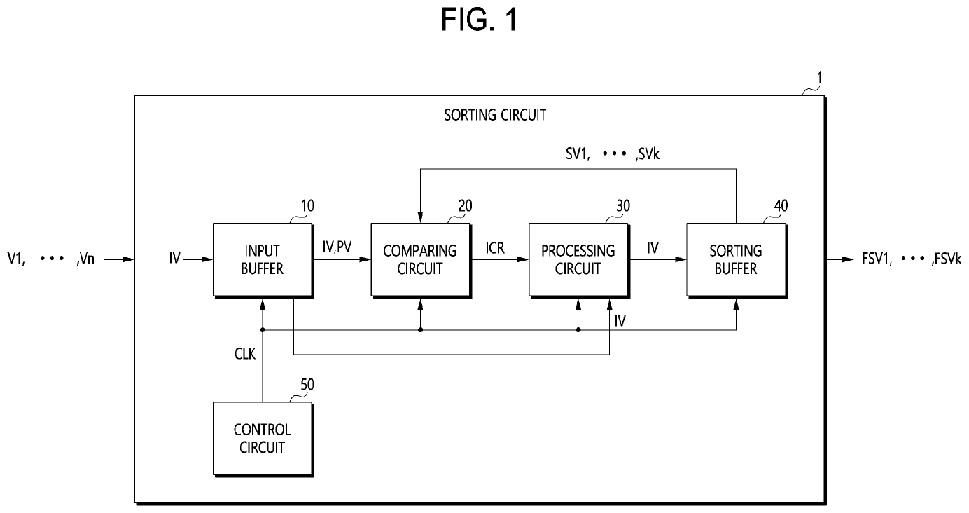

FIG. 1 is a block diagram illustrating a sorting circuit in accordance with an embodiment of the present disclosure.

The sorting circuit 1 may arrange ‘k’ number of values FSV1 to FSVk, which are greatest from among ‘n’ number of values V1 to Vn sequentially input thereto. When ‘k’ is smaller than ‘n’, the sorting circuit 1 may discard remaining values other than the ‘k’ number of greatest values FSV1 to FSVk from among the ‘n’ number of values V1 to Vn, which are sequentially input thereto, and thus the sorting circuit 1 may not output the remaining values. When ‘k’ is ‘n’ or greater, the sorting circuit 1 may arrange all the values V1 to Vn and output the arranged values V1 to Vn.

The sorting circuit 1 may include a control circuit 50, an input buffer 10, a comparing circuit 20, a processing circuit 30 and a sorting buffer 40.

The control circuit 50 may control operations of the elements included in the sorting circuit 1. The control circuit 50 may provide a clock signal CLK to each of the input buffer 10, the comparing circuit 20, the processing circuit 30 and the sorting buffer 40. Each of the input buffer 10, the comparing circuit 20, the processing circuit 30 and the sorting buffer 40 may operate in response to the clock signal CLK.

In response to the clock signal CLK, the input buffer 10 may sequentially receive the values V1 to Vn and store therein the values V1 to Vn. The input buffer 10 may operate according to a first-in-first-out (FIFO) scheme. According to a size of the input buffer 10, the input buffer 10 may store therein a part or a whole of the values V1 to Vn.

For example, the values V1 to Vn may be sequentially provided to the input buffer 10 during respective periods (i.e., respective clock periods) of the clock signal CLK. The input buffer 10 may store, in a portion indicated by a pointer, an input value IV received during a current clock period. At each clock period, the pointer may indicate a next portion within the input buffer 10. In an embodiment, the values V1 to Vn may be processed according to a different period (e.g., a half period of the clock signal CLK).

Each of the values V1 to Vn may be processed, as an input value IV, sequentially by the input buffer 10, the comparing circuit 20, the processing circuit 30 and the sorting buffer 40. The input buffer 10 may receive and store therein the input value IV in response to the clock signal CLK in a first period (i.e., time section). The input value IV may be the one that the input buffer 10 currently receives from among the values V1 to Vn. For example, the input value IV may be the one that the input buffer 10 receives during a current clock period, from among the values V1 to Vn. Here, the first period may mean not only an initial period but also any period.

In a second period subsequent to the first period, the input buffer 10 may provide, in response to the clock signal CLK, the comparing circuit 20 with the input value IV together with a previous value PV. The previous value PV may be the one that the input buffer 10 receives immediately before receiving the input value IV from among the values V1 to Vn. The previous value PV may be the one that the input buffer 10 receives during a previous clock period immediately before the current clock period, from among the values V1 to Vn.

In the second period, the comparing circuit 20 may receive, in response to the clock signal CLK, the input value IV and the previous value PV from the input buffer 10. At the same time, the comparing circuit 20 may receive, in response to the clock signal CLK, sorted values SV1 to SVk from the sorting buffer 40, the sorted values SV1 to SVk being stored in the sorting buffer 40.

In a third period subsequent to the second period, the comparing circuit 20 may compare, in response to the clock signal CLK, the input value IV with each of the previous value PV and the sorted values SV1 to SVk to provide an input value comparison result ICR to the processing circuit 30. The input value comparison result ICR may represent whether the input value IV is equal to, greater than or smaller than each of the previous value PV and the sorted values SV1 to SVk. The input value comparison result ICR may include ‘k+1’ number of comparison values, the ‘k+1’ number being a number of the previous value PV and the sorted values SV1 to SVk.

In the third period, the processing circuit 30 may receive, in response to the clock signal CLK, the input value comparison result ICR from the comparing circuit 20. In the third period, the processing circuit 30 may selectively insert the previous value PV into the sorting buffer 40.

In a fourth period subsequent to the third period, the processing circuit 30 may selectively insert, in response to the clock signal CLK, the input value IV into the sorting buffer 40 according to the input value comparison result ICR. The processing circuit 30 may receive the input value IV, which is to be inserted into the sorting buffer 40, from the input buffer 10.

The processing circuit 30 may determine to discard the input value IV when the input value IV is smaller than the sorted values SV1 to SVk. When the input value IV is equal to or greater than at least one from among the sorted values SV1 to SVk and equal to or greater than the previous value PV, the processing circuit 30 may determine to insert the input value IV into the sorting buffer 40. When the input value IV is equal to or greater than only the smallest one from among the sorted values SV1 to SVk and smaller than the previous value PV, the processing circuit 30 may determine to discard the input value IV. When the input value IV is equal to or greater than at least two from among the sorted values SV1 to SVk, the processing circuit 30 may determine to insert the input value IV into the sorting buffer 40.

As each of the values V1 to Vn is determined to be discarded or inserted into the sorting buffer 40, the sorting buffer 40 may store therein one or more selected values from among the values V1 to Vn. The sorting buffer 40 may store the ‘k’ number of the sorted values SV1 to SVk, which are arranged in a descending order, under the control of the processing circuit 30. As described above, the ‘k’ number of the sorted values SV1 to SVk may be the ones being stored in the sorting buffer 40 when the comparing circuit 20 receives the input value IV. That is, the sorted values SV1 to SVk may be the values being stored in the sorting buffer 40 immediately before the previous value PV is inserted into the sorting buffer 40. That is, the sorted values SV1 to SVk may not include the previous value PV. At the time point when the input value IV is inserted into the sorting buffer 40, the sorting buffer 40 may be in a state (i.e., the discarding or the insert of the previous value PV) in which the process on the previous value PV is already reflected thereto.

The sorting buffer 40 may include ‘k’ number of portions from a head portion to a tail portion. The head portion may store therein the greatest one from among the sorted values SV1 to SVk and the tail portion may store therein the smallest one from among the sorted values SV1 to SVk. The ‘k’ may represent the size of the sorting buffer 40. When the input value IV is inserted into the sorting buffer 40 under the control of the processing circuit 30, each value smaller than the input value IV from among the sorted values SV1 to SVk, which are stored in the sorting buffer 40, may shift toward the tail portion and the smallest value from among the sorted values SV1 to SVk may be discarded from the sorting buffer 40.

In an embodiment, each of the input buffer 10 and the sorting buffer 40 may further store therein an identifier assigned to the input value IV. When inserting the input value IV into the sorting buffer 40, the processing circuit 30 may further receive, from the input buffer 10, the identifier allocated to the input value IV and may store, in the sorting buffer 40, the input value IV together with the identifier.

To sum up, the sorting buffer 40 may be in a state in which the process on the previous value PV is not yet reflected to the sorting buffer 40 at the time point when the comparing circuit 20 receives the input value IV for the comparison. In this case, since the comparing circuit 20 waits for the process on the previous value PV to be reflected to the sorting buffer 40 and then compares the input value IV with the values stored in the sorting buffer 40, it may not be effective due to the increased latency. According to an embodiment, the comparing circuit 20 should not wait for the process on the previous value PV to be reflected to the sorting buffer 40 and rather may compare the input value IV with the sorted values SV1 to SVk, to which the process on the previous value PV is not reflected, while separately comparing the input value IV with the previous value PV. After that, when the input value IV is inserted into the sorting buffer 40, the sorting buffer 40 may be in a state in which the process on the previous value PV is reflected to the sorting buffer 40 and the processing circuit 30 may appropriately insert, based on the input value comparison result ICR from the comparing circuit 20, the input value IV into the sorting buffer 40, to which the process on the previous value PV is reflected. Therefore, according to an embodiment, the sorting circuit 1 may be capable of performing the sorting operation with minimized latency.

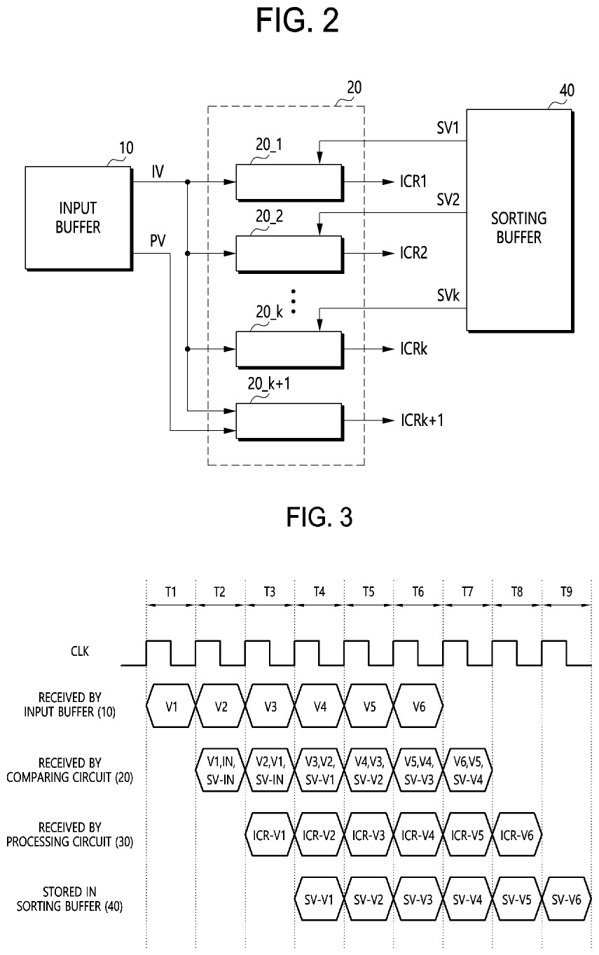

FIG. 2 is a block diagram illustrating the comparing circuit 20 of FIG. 1 in detail in accordance with an embodiment of the present disclosure.

When ‘k’ is the size of the sorting buffer 40, the comparing circuit 20 may include ‘k+1’ number of sub-comparing circuits 20_1 to 20_k+1.

From among the sub-comparing circuits 20_1 to 20_k+1, the sub-comparing circuits 20_1 to 20_k may operate in parallel. In response to the clock signal CLK, each of the sub-comparing circuits 20_1 to 20_k may receive the input value IV and a corresponding one from among the sorted values SV1 to SVk, may compare the input value IV with the corresponding one from among the sorted values SV1 to SVk and may output a corresponding one of comparison values ICR1 to ICRk. In a similar way, in response to the clock signal CLK, the sub-comparing circuit 20_k+1 may receive the input value IV and the previous value PV, may compare the input value IV with the previous value PV and may output a comparison value ICRk+1. The comparison values ICR1 to ICRk+1 may be included in the input value comparison result ICR of FIG. 1.

For example, the sub-comparing circuit 20_1 may compare the input value IV with the sorted value SV1 to output the comparison value ICR1. The comparison value ICR1 may have a first result value when the input value IV is equal to or greater than the sorted value SV1 and may have a second result value when the input value IV is smaller than the sorted value SV1. Each of the sub-comparing circuits 20_2 to 20_k+1 may operate in a similar manner to the sub-comparing circuit 20_1.

FIG. 3 is a timing diagram for describing an operation of the sorting circuit 1 of FIG. 1 in accordance with an embodiment of the present disclosure.

Referring to FIG. 3, the sorting circuit 1 may operate from a period T1 to a period T9 in response to the clock signal CLK. For example, each of the periods T1 to T9 may correspond to a single clock period. According to an embodiment, each of the periods T1 to T9 may correspond to a half of the single clock period.

The sorting circuit 1 may sequentially receive a first value V1 to a sixth value V6 in the periods T1 to T6, respectively. Each of the first value V1 to the sixth value V6 may be a positive number, which is an example and will not limit the scope of the present disclosure. Before receiving the first value V1, each of the input buffer 10 and the sorting buffer 40 may be initialized to store therein an initial value (e.g., a value of zero (0)). The size (i.e., ‘k’) of the sorting buffer 40 may be one (1) or greater.

The first value V1 may be processed as follows. In the period T1, the input buffer 10 may receive the first value V1. That is, the first value V1 may be provided as the input value IV to the input buffer 10 in the period T1.

In the period T2, the comparing circuit 20 may receive the first value V1, an initial value IN and sorted values SV-IN stored in the sorting buffer 40. The sorted values SV-IN may be provided, to the comparing circuit 20, as the sorted values SV1 to SVk of FIG. 1. The initial value IN may be provided as the previous value PV to the comparing circuit 20.

The sub-comparing circuits 20_1 to 20_k may receive the first value V1 from the input buffer 10 and may respectively receive the sorted values SV-IN from the sorting buffer 40. Because the sorting buffer 40 is not yet updated at this time point, the sorted values SV-IN may be all initial values. At the same time, the sub-comparing circuit 20_k+1 may receive the first value V1 and the initial value IN from the input buffer 10.

In the period T3, the processing circuit 30 may receive, from the comparing circuit 20, the comparison result ICR-V1 of the first value V1. That is, the comparison result ICR-V1 of the first value V1 may be input, to the processing circuit 30, as the input value comparison result ICR of FIG. 1. The comparison result ICR-V1 of the first value V1 may include the comparison values ICR1 to ICRk+1 of FIG. 2.

Each of the sub-comparing circuits 20_1 to 20_k may compare the first value V1 with a corresponding one from among the sorted values SV-IN to output, to the processing circuit 30, a corresponding one of the comparison values ICR1 to ICRk. At the same time, the sub-comparing circuit 20_k+1 may compare the first value V1 with the initial value IN to output the comparison value ICRk+1 to the processing circuit 30. The comparison values ICR1 to ICRk+1 may indicate that the first value V1 is greater than the initial value IN.

In the period T4, the processing circuit 30 may insert the first value V1 into the sorting buffer 40 based on the comparison result ICR-V1 of the first value V1. Because the first value V1 is greater than the initial value stored in the sorting buffer 40, the first value V1 may be stored in the head portion within the sorting buffer 40. The sorting buffer 40 may store therein sorted values SV-V1, into which the first value V1 is inserted.

The second value V2 may be processed as follows. In the period T2, the input buffer 10 may receive the second value V2. That is, the second value V2 may be provided as the input value IV of FIG. 1 to the input buffer 10 in the period T2.

In the period T3, the comparing circuit 20 may receive the second value V2, the first value V1 and the sorted values SV-IN stored in the sorting buffer 40. The sorted values SV-IN may be provided, to the comparing circuit 20, as the sorted values SV1 to SVk of FIG. 1. The first value V1 may be provided as the previous value PV of FIG. 1 to the comparing circuit 20.

The sub-comparing circuits 20_1 to 20_k may receive the second value V2 from the input buffer 10 and may respectively receive the sorted values SV-IN from the sorting buffer 40. Because the sorting buffer 40 is not yet updated at this time point, the sorted values SV-IN may be all initial values. At the same time, the sub-comparing circuit 20_k+1 may receive the second value V2 and the first value V1 from the input buffer 10.

In the period T4, the processing circuit 30 may receive, from the comparing circuit 20, the comparison result ICR-V2 of the second value V2. That is, the comparison result ICR-V2 of the second value V2 may be input, to the processing circuit 30, as the input value comparison result ICR of FIG. 1. The comparison result ICR-V2 of the second value V2 may include the comparison values ICR1 to ICRk+1 of FIG. 2.

Each of the sub-comparing circuits 20_1 to 20_k may compare the second value V2 with a corresponding one from among the sorted values SV-IN to output, to the processing circuit 30, a corresponding one of the comparison values ICR1 to ICRk. At the same time, the sub-comparing circuit 20_k+1 may compare the second value V2 with the first value V1 to output the comparison value ICRk+1 to the processing circuit 30.

In the period T5, the processing circuit 30 may selectively insert the second value V2 into the sorting buffer 40 based on the comparison result ICR-V2 of the second value V2. The sorting buffer 40 may store therein sorted values SV-V2, into which the process on the second value V2 (i.e., the discard or the insert of the second value V2) is reflected.

The third value V3 may be processed as follows. In the period T3, the input buffer 10 may receive the third value V3. That is, the third value V3 may be provided as the input value IV of FIG. 1 to the input buffer 10 in the period T3.

In the period T4, the comparing circuit 20 may receive the third value V3, the second value V2 and the sorted values SV-V1 stored in the sorting buffer 40. The sorted values SV-V1 may be provided, to the comparing circuit 20, as the sorted values SV1 to SVk of FIG. 1. The second value V2 may be provided as the previous value PV of FIG. 1 to the comparing circuit 20.

The sub-comparing circuits 20_1 to 20_k may receive the third value V3 from the input buffer 10 and may respectively receive the sorted values SV-V1 from the sorting buffer 40. Because the sorting buffer 40 is storing therein the first value V1 at this time point, the sorted values SV-V1 may include the first value V1 and initial values. At the same time, the sub-comparing circuit 20_k+1 may receive the third value V3 and the second value V2 from the input buffer 10.

In the period T5, the processing circuit 30 may receive, from the comparing circuit 20, the comparison result ICR-V3 of the third value V3. That is, the comparison result ICR-V3 of the third value V3 may be input, to the processing circuit 30, as the input value comparison result ICR of FIG. 1. The comparison result ICR-V3 of the third value V3 may include the comparison values ICR1 to ICRk+1 of FIG. 2.

Each of the sub-comparing circuits 20_1 to 20_k may compare the third value V3 with a corresponding one from among the sorted values SV-V1 to output, to the processing circuit 30, a corresponding one of the comparison values ICR1 to ICRk. At the same time, the sub-comparing circuit 20_k+1 may compare the third value V3 with the second value V2 to output the comparison value ICRk+1 to the processing circuit 30.

In the period T6, the processing circuit 30 may selectively insert the third value V3 into the sorting buffer 40 based on the comparison result ICR-V3 of the third value V3. The sorting buffer 40 may store therein sorted values SV-V3, into which the process on the third value V3 (i.e., the discard or the insert of the third value V3) is reflected.

The fourth value V4 may be processed as follows. In the period T4, the input buffer 10 may receive the fourth value V4. That is, the fourth value V4 may be provided as the input value IV of FIG. 1 to the input buffer 10 in the period T4.

In the period T5, the comparing circuit 20 may receive the fourth value V4, the third value V3 and the sorted values SV-V2 stored in the sorting buffer 40. The sorted values SV-V2 may be provided, to the comparing circuit 20, as the sorted values SV1 to SVk of FIG. 1. The third value V3 may be provided as the previous value PV of FIG. 1 to the comparing circuit 20.

The sub-comparing circuits 20_1 to 20_k may receive the fourth value V4 from the input buffer 10 and may respectively receive the sorted values SV-V2 from the sorting buffer 40. Because the sorting buffer 40 is storing therein the first value V1 and the second value V2 at this time point, the sorted values SV-V2 may include the first value V1, the second value V2 and initial values. At the same time, the sub-comparing circuit 20_k+1 may receive the fourth value V4 and the third value V3 from the input buffer 10.

In the period T6, the processing circuit 30 may receive, from the comparing circuit 20, the comparison result ICR-V4 of the fourth value V4. That is, the comparison result ICR-V4 of the fourth value V4 may be input, to the processing circuit 30, as the input value comparison result ICR of FIG. 1. The comparison result ICR-V4 of the fourth value V4 may include the comparison values ICR1 to ICRk+1 of FIG. 2.

Each of the sub-comparing circuits 20_1 to 20_k may compare the fourth value V4 with a corresponding one from among the sorted values SV-V2 to output, to the processing circuit 30, a corresponding one of the comparison values ICR1 to ICRk. At the same time, the sub-comparing circuit 20_k+1 may compare the fourth value V4 with the third value V3 to output the comparison value ICRk+1 to the processing circuit 30.

In the period T7, the processing circuit 30 may selectively insert the fourth value V4 into the sorting buffer 40 based on the comparison result ICR-V4 of the fourth value V4. The sorting buffer 40 may store therein sorted values SV-V4, into which the process on the fourth value V4 (i.e., the discard or the insert of the fourth value V4) is reflected.

In a similar manner to the above description, the sorting circuit 1 may process the fifth value V5 in the periods T5 to T8 and may process the sixth value V6 in the periods T6 to T9.

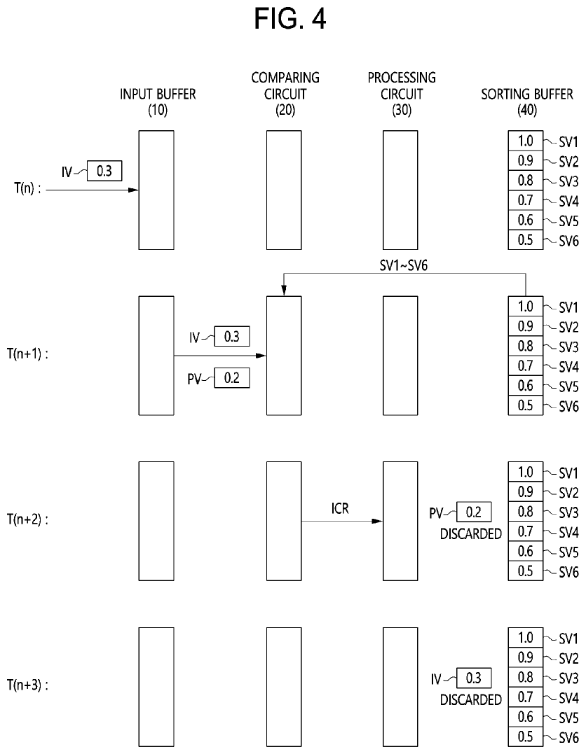

FIGS. 4 to 10 are diagrams illustrating operations of the processing circuit 30 of FIG. 1 for various cases in accordance with an embodiment of the present disclosure. Hereinafter, described with reference to FIGS. 4 to 10 will be the operations of the processing circuit 30 according to the input value comparison result ICR. In FIGS. 4 to 10, the size (i.e., ‘k’) of the sorting buffer 40 may be six (6) as an example. In FIGS. 4 to 10, the sorted values SV1 to SV6 may be the values, into which the process on the previous value PV (i.e., the discard or the insert of the previous value PV) is not yet reflected. That is, the sorted values SV1 to SV6 may be a result of sorting values that are input prior to the previous value PV.

Referring to FIG. 4, the input value IV may be smaller than the sorted values SV1 to SV6 and may be greater than the previous value PV. Such size relationship may be provided, to the processing circuit 30, as the input value comparison result ICR. In this case, the processing circuit 30 may discard, based on the input value comparison result ICR, the input value IV instead of inserting the input value IV into the sorting buffer 40. The previous value PV may be discarded without being inserted into the sorting buffer 40. Although not illustrated, the previous value PV may be processed in a similar manner to the input value IV.

Each of n-th period T(n) to (n+3)-th period T(n+3) may correspond to a single clock period, for example. In the n-th period T(n), the input buffer 10 may receive the input value IV.

In the (n+1)-th period T (n+1), the comparing circuit 20 may receive the input value IV and the previous value PV from the input buffer 10 and may receive the sorted values SV1 to SV6 from the sorting buffer 40. It is illustrated that the sorted values SV1 to SV6 stay unchanged in the n-th period T(n) and the (n+1)-th period T(n+1).

In the (n+2)-th period T(n+2), the processing circuit 30 may receive the input value comparison result ICR from the comparing circuit 20. The input value comparison result ICR may indicate that the input value IV is smaller than the sorted values SV1 to SV6 and greater than the previous value PV. At the same time, the processing circuit 30 may discard the previous value PV. Although not illustrated, the processing circuit 30 may discard the previous value PV based on the comparison result of the previous value PV, the comparison result being provided from the comparing circuit 20.

In the (n+3)-th period T(n+3), the processing circuit 30 may discard the input value IV based on the input value comparison result ICR. Therefore, the sorting buffer 40 may properly store therein the arranged valued in consideration of the input value IV.

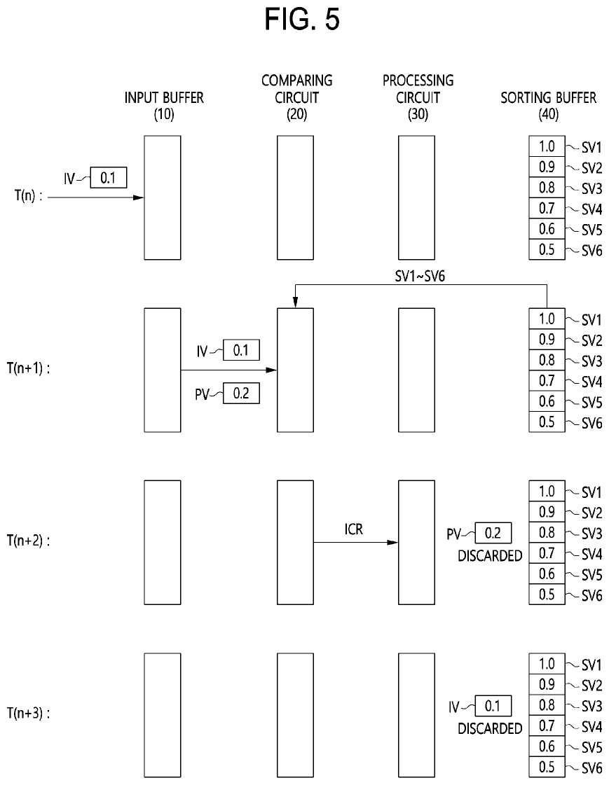

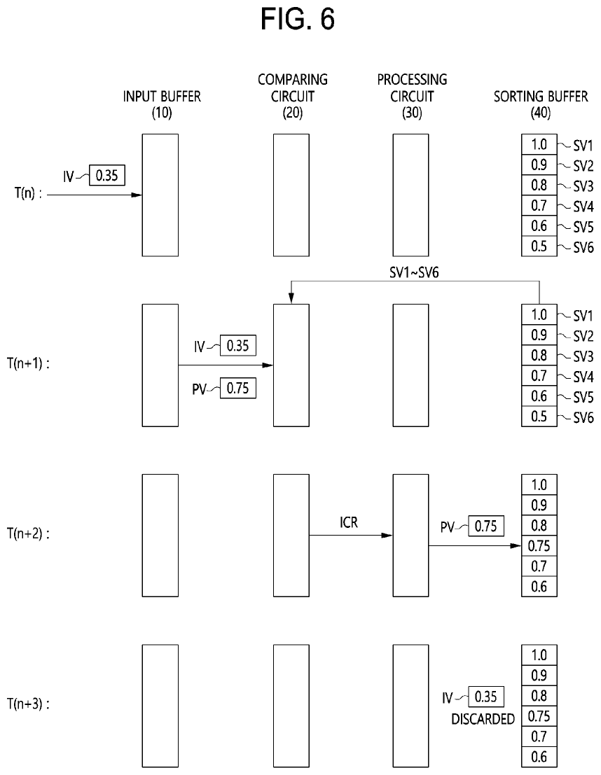

Referring to FIGS. 5 and 6, the input value IV may be smaller than the sorted values SV1 to SV6 and may be smaller than the previous value PV. Such a size relationship may be provided, to the processing circuit 30, as the input value comparison result ICR. In this case, the processing circuit 30 may discard, based on the input value comparison result ICR, the input value IV instead of inserting the input value IV into the sorting buffer 40. However, the sorting buffer 40 may store therein different values according to a processing result of the previous value PV. FIG. 5 illustrates the case in which the previous value PV is discarded without being inserted into the sorting buffer 40. FIG. 6 illustrates the case in which the previous value PV is inserted into the sorting buffer 40.

In an embodiment, when the input value IV is smaller than the sorted values SV1 to SV6, as discussed with reference to FIGS. 4 to 6, the processing circuit 30 may determine to discard the input value IV without inserting the input value IV into the sorting buffer 40 regardless of the comparison result between the input value IV and the previous value PV.

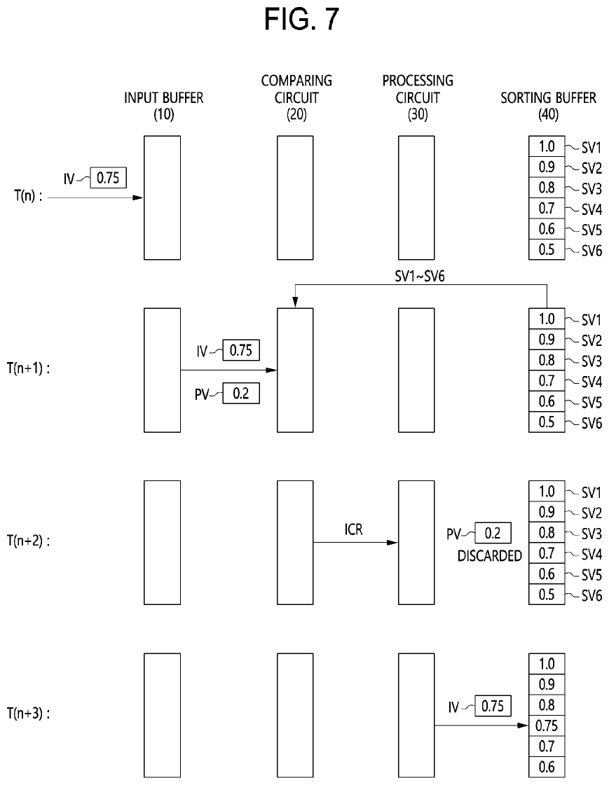

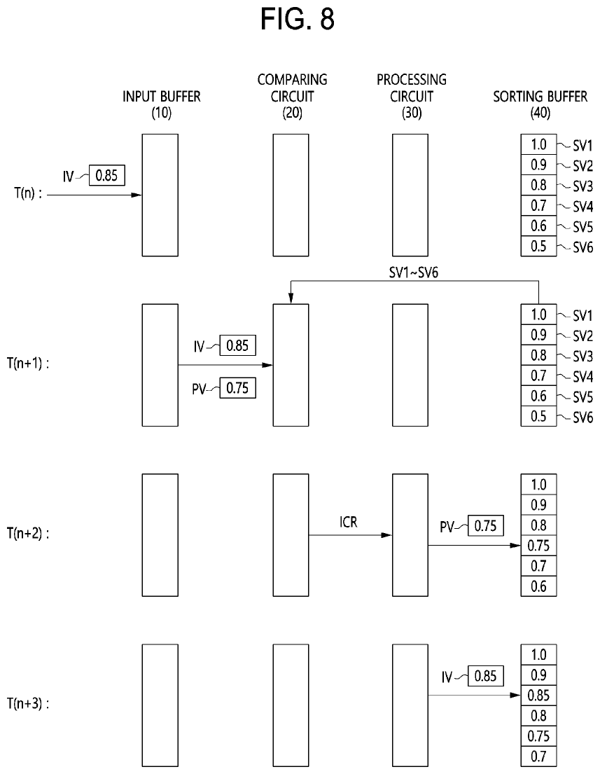

Referring to FIGS. 7 and 8, the input value IV may be greater than at least one from among the sorted values SV1 to SV6 and may be greater than the previous value PV. Such a size relationship may be provided, to the processing circuit 30, as the input value comparison result ICR. In this case, the processing circuit 30 may insert, based on the input value comparison result ICR, the input value IV into a proper portion within the sorting buffer 40. However, the sorting buffer 40 may store therein different values according to a processing result of the previous value PV.

FIG. 7 illustrates the case in which the previous value PV is discarded without being inserted into the sorting buffer 40. In this case, the processing circuit 30 may insert, based on the input value comparison result ICR, the input value IV into a proper portion within the sorting buffer 40 such that the input value IV and remaining values SV1 to SV5, which are other than the smallest value SV6 from among the sorted values SV1 to SV6, are arranged in a descending order within the sorting buffer 40. The smallest value SV6 from among the sorted values SV1 to SV6 may be discarded.

FIG. 8 illustrates the case in which the previous value PV is inserted into the sorting buffer 40. In this case, the processing circuit 30 may insert, based on the input value comparison result ICR, the input value IV into a proper portion within the sorting buffer 40 such that the input value IV, the previous value PV and remaining values SV1 to SV4, which are other than the smallest two values SV5 and SV6 from among the sorted values SV1 to SV6, are arranged in a descending order within the sorting buffer 40. The smallest two values SV5 and SV6 from among the sorted values SV1 to SV6 may be discarded.

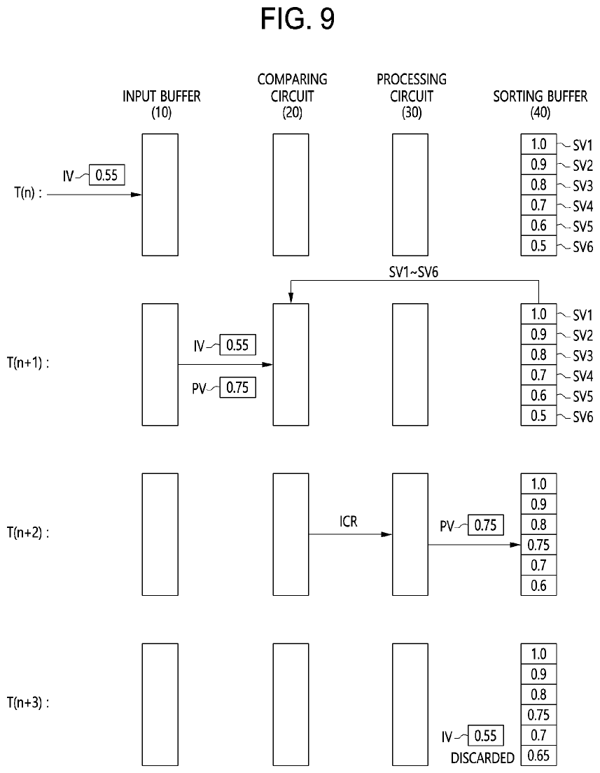

Referring to FIG. 9, the input value IV may be greater than only the smallest one SV6 from among the sorted values SV1 to SV6 and may be smaller than the previous value PV. Such a size relationship may be provided, to the processing circuit 30, as the input value comparison result ICR. In this case, the processing circuit 30 may discard, based on the input value comparison result ICR, the input value IV instead of inserting the input value IV into the sorting buffer 40. The previous value PV may be inserted into the sorting buffer 40. That is, it is the case in which the previous value PV is inserted into the sorting buffer 40 to replace the value V6, which is the only one value smaller than the input value IV from among the sorted values SV1 to SV6, and the value V6 is discarded from the sorting buffer 40.

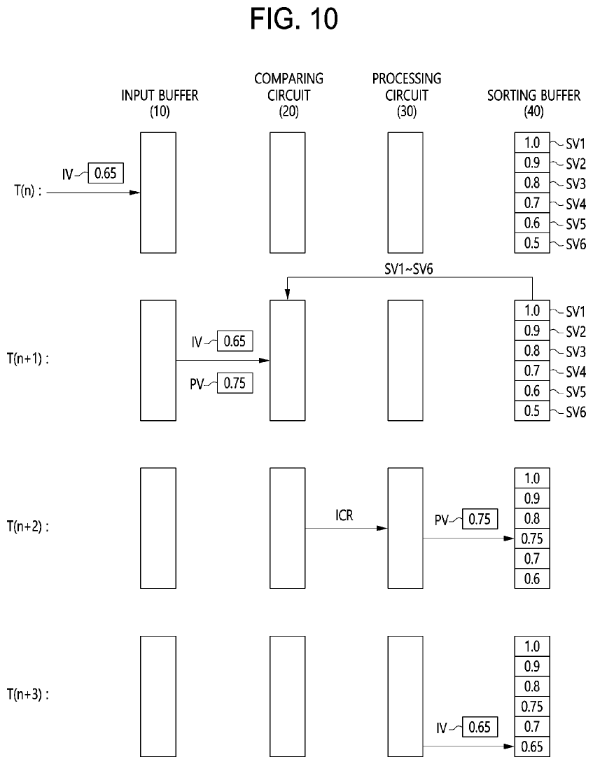

Referring to FIG. 10, the input value IV may be greater than the smallest two values SV5 and SV6 from among the sorted values SV1 to SV6. Such a size relationship may be provided, to the processing circuit 30, as the input value comparison result ICR. In this case, the processing circuit 30 may determine to insert, based on the input value comparison result ICR, the input value IV into a proper portion within the sorting buffer 40. For example, the previous value PV may also be inserted into the sorting buffer 40. The processing circuit 30 may insert the input value IV into a proper portion within the sorting buffer 40 such that the input value IV, the previous value PV and remaining values SV1 to SV4, which are other than the smallest two values SV5 and SV6 from among the sorted values SV1 to SV6, are arranged in a descending order within the sorting buffer 40. The smallest two values SV5 and SV6 from among the sorted values SV1 to SV6 may be discarded.

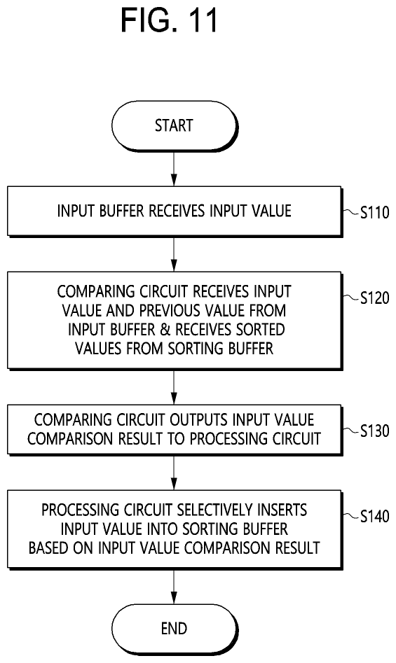

FIG. 11 is a flowchart for describing an operation of the sorting circuit 1 of FIG. 1 in accordance with an embodiment of the present disclosure.

Referring to FIG. 11, at operation S110, the input buffer 10 may receive the input value IV.

At operation S120, the comparing circuit 20 may receive the input value IV and the previous value PV from the input buffer 10 and may receive the sorted values SV1 to SVk from the sorting buffer 40.

At operation S130, the comparing circuit 20 may output the input value comparison result ICR to the processing circuit 30.

At operation S140, the processing circuit 30 may selectively insert the input value IV into the sorting buffer 40 based on the input value comparison result ICR. The processing circuit 30 may determine to discard the input value IV when the input value IV is smaller than the sorted values SV1 to SVk. When the input value IV is equal to or greater than at least one from among the sorted values SV1 to SVk and equal to or greater than the previous value PV, the processing circuit 30 may determine to insert the input value IV into the sorting buffer 40. When the input value IV is equal to or greater than only the smallest one from among the sorted values SV1 to SVk and smaller than the previous value PV, the processing circuit 30 may determine to discard the input value IV. When the input value IV is equal to or greater than at least two from among the sorted values SV1 to SVk, the processing circuit 30 may determine to insert the input value IV into the sorting buffer 40.

In accordance with embodiments of the present disclosure, the sorting circuit and the operating method thereof may efficiently perform a sorting operation with minimized latency.

While certain embodiments have been described above, it will be understood to those skilled in the art that the embodiments described are by way of example only. Accordingly, the sorting circuit and the operating method thereof should not be limited based on the described embodiments. Rather, the sorting circuit and the operating method thereof described herein should only be limited in light of the claims that follow when taken in conjunction with the above description and accompanying drawings. Furthermore, the embodiments may be combined to form additional embodiments.

What is claimed is:

1. A sorting circuit comprising:
an input buffer configured to sequentially receive values and sequentially store therein the values;
a sorting buffer configured to store therein selected ones from among the values as each of the values is inserted thereto or discarded;
a comparing circuit configured to compare an input value currently received from among the values with each of a previous value and sorted values and output an input value comparison result, wherein the previous value is a value that the input buffer receives immediately before receiving the input value, from among the values, and the sorted values are values stored in the sorting buffer immediately before the previous value is discarded or inserted into the sorting buffer; and
a processing circuit configured to selectively insert, based on the input value comparison result, the input value into the sorting buffer.

2. The sorting circuit of claim 1,
wherein the input buffer is configured to receive the input value in a first period,
wherein the comparing circuit is configured to receive the input value and the previous value from the input buffer and receive the sorted values from the sorting buffer, in a second period, and output the input value comparison result to the processing circuit in a third period, and
wherein the processing circuit is configured to selectively insert the input value into the sorting buffer in a fourth period.

3. The sorting circuit of claim 2, wherein the processing circuit is configured to selectively insert the previous value into the sorting buffer in the third period.

4. The sorting circuit of claim 3, wherein the comparing circuit is configured to:
receive, from the input buffer, the input value and a value subsequent to the input value, and
receive, from the sorting buffer, newly sorted values in which the previous value is discarded or inserted thereto, in the third period.

5. The sorting circuit of claim 1, wherein the input buffer is configured to sequentially output, to the comparing circuit, the values according to a first-in-first-out (FIFO) scheme.

6. An operating method of a sorting circuit, the operating method comprising:
receiving, by a comparing circuit, a current input value, a previous value and sorted values to compare the current input value with each of the previous value and the sorted values;
outputting, by the comparing circuit, an input value comparison result to a processing circuit; and
selectively inserting, by the processing circuit, the current input value into a sorting buffer based on the input value comparison result.

7. The operating method of claim 6, wherein the sorted values are values that are stored in the sorting buffer immediately before the previous value is discarded or inserted into the sorting buffer.

8. The operating method of claim 6, further comprising selectively inserting, by the processing circuit, the previous value into the sorting buffer when receiving the input value comparison result.

9. The operating method of claim 6, wherein the selectively inserting the current input value into the sorting buffer includes determining to discard the current input value without inserting the current input value into the sorting buffer when the current input value is smaller than the sorted values.

10. The operating method of claim 6, wherein the selectively inserting the current input value into the sorting buffer includes determining to insert the current input value into the sorting buffer when the current input value is equal to or greater than at least one of the sorted values and equal to or greater than the previous value.

11. The operating method of claim 10, wherein the sorting buffer stores therein the current input value and remaining values, which are other than a smallest one from among the sorted values, when the current input value is inserted into the sorting buffer and the previous value is not inserted into the sorting buffer, and
wherein the current input value and the remaining values are arranged in a descending order to be stored in the sorting buffer.

12. The operating method of claim 10, wherein the sorting buffer stores therein the current input value, the previous value and remaining values, which are other than smallest two from among the sorted values, when the current input value and the previous value are inserted into the sorting buffer, and
wherein the current input value, the previous value and the remaining values are arranged in a descending order to be stored in the sorting buffer.

13. The operating method of claim 6, wherein the selectively inserting the current input value into the sorting buffer includes determining to discard the current input value without inserting the current input value into the sorting buffer when the current input value is equal to or greater than only one of the sorted values and smaller than the previous value.

14. The operating method of claim 6, wherein the selectively inserting the current input value into the sorting buffer includes determining to insert the current input value into the sorting buffer when the current input value is equal to or greater than at least two of the sorted values.

15. A sorting circuit comprising:
a sorting buffer configured to store therein a predetermined number of values that are selected in a descending order from among sequentially received values; and
a processing circuit configured to:
determine to discard an input value currently received when the input value is equal to or greater than only one of sorted values and smaller than a previous value, which is received immediately before receiving the input value, and
determine to insert the input value into the sorting buffer when the input value is equal to or greater than at least two of the sorted values,
wherein the sorted values are values stored in the sorting buffer immediately before the previous value is discarded or inserted into the sorting buffer.

16. The sorting circuit of claim 15, wherein the processing circuit is configured to discard the input value when the input value is smaller than the sorted values.

17. The sorting circuit of claim 15, wherein the processing circuit is configured to determine to insert the input value into the sorting buffer when the input value is equal to or greater than at least one of the sorted values and equal to or greater than the previous value.
